(19) United States
(12) Patent Application Publication
(10) Pub. No.: US 2026/0318783 A1
(43) Pub. Date: Oct. 15, 2026

(54) ROLLER ASSEMBLY, VEHICLE TEST STAND COMPRISING AT LEAST ONE ROLLER ASSEMBLY, AND METHOD FOR OPERATING SUCH A VEHICLE TEST STAND

(71) Applicant: DÜRR Assembly Products GmbH, Püttlingen (DE)

(72) Inventors: Ismail KURT, Völklingen (DE); Andre DEUTSCH, Herbitzheim (FR); Joachim KAUFMANN, Saarlouis (DE); Stefan ROTHFUCHS, Schiffweiler (DE); Jannis LAUB, Marpingen (DE)

(21) Appl. No.: 19/479,668

(22) PCT Filed: May 23, 2024
(86) PCT No.: PCT/DE2024/100476

§ 371 Date: Oct. 28, 2025

(30) Foreign Application Priority Data
Jun. 15, 2023 (DE) 10 2023 115 725.6

(51) Int. Cl. G01M 17/06; G01M 17/02

(52) U.S. Cl. CPC G01M 17/065; G01M 17/022

(57) ABSTRACT

The invention relates to a roller assembly (100) for a vehicle test stand (1000), having a vertical axis (Z), a transverse axis (Y), and a longitudinal axis (X). The roller assembly (100) comprises a support (10); and a roller set (12) arranged on the support (10), comprising rollers (14, 16) which are arranged parallel to one another and which form a horizontal wheel receiving area. A lifting bar (50) which can be moved in the direction of the vertical axis (Z) is arranged in a clear free space (20) between the two rollers (14, 16), said lifting bar (50) having a floating plate (60) on the upper face. The invention additionally relates to a vehicle test stand (1000) comprising at least one such roller assembly (100), to a method for operating such a vehicle test stand (1000), to a computer program product, to a computer program, and to a computer-readable medium.

### FIELD OF THE DISCLOSURE

The present disclosure relates to a roller assembly, to a vehicle test stand having at least one roller assembly, and to a method for operating such a vehicle test stand.

### BACKGROUND

EP 1143219 B1 discloses a method and an apparatus for positioning a vehicle on a vehicle test stand for measuring and adjusting toe and camber angles of the wheels. The wheels each stand on, for example, two rollers which form a horizontal wheel holder. To position the vehicle in a lateral direction, each wheel holder is mounted so as to be rotatable about a pivot point and is positioned with respect to the respective wheel plane by being rotated about the pivot point.

### SUMMARY

One problem addressed by examples disclosed herein is the creation of a versatile roller assembly.

A further problem addressed by examples disclosed herein is the creation of a vehicle test stand having at least one versatile roller assembly.

A further problem addressed by examples disclosed herein is the creation of a method for operating such a vehicle test stand having at least one versatile roller assembly.

The problems are solved by the features of the independent claims. Favorable embodiments and advantages of examples disclosed herein will become apparent from the further claims, the description and the drawing.

A roller assembly for a vehicle test stand, having a vertical axis, a transverse axis and a longitudinal axis, is proposed, comprising (a) a support; and (b) a roller set, arranged on the support, with rollers that are arranged parallel to one another and form a horizontal wheel holder, wherein a lifting bar that is movable in the direction of the vertical axis is arranged in a clear free space between two of the rollers and the lifting bar has a floating plate on its top side.

Optionally, the roller assembly may have a drive unit for driving at least one roller of the roller set, in particular an electric motor. This may be integrated into a roller or be a separate unit. The drive unit may be connected to the roller set for conjoint rotation. In this case, the drive unit can rotate conjointly with the roller set if the roller set is rotated about the vertical axis. Alternatively, the drive unit may be connected to the roller set via a coupling, such that the roller set can be rotated with respect to the drive unit, but can remain operatively connected. The drive unit may, in this case, be arranged on the support or on a base frame on which the roller assembly is arranged when used as intended.

The lifting bar itself serves for driving on the roller set of the roller set without problems. Since the lifting bar has a floating plate on its top side, which can come into contact with the wheel of the vehicle, the roller assembly advantageously allows a combination of functions of two different test stands.

Advantageously, savings are possible, since various devices need to be present only once, for instance the base frame of the vehicle test stand. The roller assemblies also need to be present only on the one test stand, and test stand control needs to be carried out only once.

By means of the vehicle test stand, a rolling test stand is realized, in which wheels of at least one vehicle axle are, for example, driven, braked or can run freely by way of the rollers. This can be carried out in a conventional manner for the rolling test, in which a general functional test of the vehicle takes place in the dynamic test mode, for the transmission function test, for testing the brake system of the vehicle, for acceleration tests and deceleration tests under road-like conditions, and for testing various sensors in the vehicle, such as sensors of the antilock brake system (ABS), sensors of an electronic stability program (ESP), and sensors of a traction control system (TCS).

Moreover, by means of the vehicle test stand, a chassis test stand is realized, in which a reversal measurement is carried out on the chassis, and chassis adjustment can be undertaken. To this end, the floating plate of the lifting bar is used.

Essential chassis geometric parameters are the individual toe angle and total toe angle, the camber angle, and the caster angle. In this case, the individual toe angles of the rear axle determine the direction of travel of the vehicle. Similarly, a vehicle height can be determined. In particular, the precise position of the highest position of the wheel arch edge can be determined. A vehicle axle with the wheels can be free of mechanical stresses in that the floating plate of the lifting bar adapts its rotational and translational position accordingly. This is particularly favorable when measuring the vehicle. This allows an area-based 3D measuring technique on the wheel and also optionally contactless vehicle positioning. By means of the floating plate integrated into the lifting bar, the wheel holders can allow the rotation of the wheels free of lateral forces, and toe adjustment and also camber adjustment on the standing wheel without noticeable resistance.

In a conventional vehicle test stand, the roller set is typically mounted on a floating plate. Since, however, by contrast, the floating plate is integrated, according to examples disclosed herein, into the lifting bar, which can be moved back and forth in the direction of the vertical axis, the roller set or the floating plate can selectively be used during tests on the same vehicle test stand.

The floating plate integrated into the lifting bar accordingly represents a floating plate that is reduced in size compared with the prior art. The adjustment and measurement of chassis properties take place in the lifted state on the floating plate or lifting bar.

To this end, the spacing of the two rollers between which the lifting bar is arranged is dimensioned to be sufficiently large to achieve secure placement of a wheel on the lifting bar or the floating plate.

In this case, it may be advantageous when the floating plate is arranged at least on one side of the lifting bar. Preferably, this is the side which corresponds to the inner side of the wheel on which adjustments for example to a tie rod of the vehicle can be undertaken. As a result of such placement, it is easier to access, for example, tie rods close to the inner side of the wheel.

The functions of the rolling test stand and those of the chassis test stand can be executed in any desired order, or be carried out as alternatives. Similarly, each individual function of the test can be repeated as required.

In this way, a roller assembly for a vehicle test stand can be created, which is advantageously also suitable for small model ranges, in which only a relatively small number of vehicles are manufactured, these then being tested following assembly. This is the case, in particular, for electric vehicles. In these vehicles, in particular a charging behavior of the battery at moderate speeds is of interest. Expediently, to this end, the wheels are driven in a rolling test at about 80-90 km/h.

The modular structure allows appropriate use. Furthermore, expansion of the vehicle test stand is possible as required.

Advantageously, precise measurements or determinations of the chassis parameters, such as toe, camber, height, caster, and the like, can be carried out, and precise adjustment of the chassis parameters can take place.

For precise measurement of the chassis geometry on the tire outer side, while simultaneously taking into consideration the wheel runout, the vehicle wheels can be rotated uniformly. This can take place advantageously at a low speed, for example 5 km/h, preferably 2 km/h, particularly preferably in the range between 1-2 km/h. This takes place with the aid of the driven rollers. Depending on the vehicle, the speed may also be higher.

According to a favorable embodiment of the roller assembly, a positioning device may be provided, which guides the lifting bar, in a lowered state, at least in the direction of the transverse axis into a home position and/or secures it in a home position. Advantageously, the position of the lifting bar in the lowered state can be reliably adjusted. As a result, at the same time, the position of the floating plate is defined reproducibly in a defined manner. Advantageously, as a result, a basic position of the lifting define can be defined. Favorably, upon deflection of the lifting bar, the lifting bar can be reliably restored into the defined basic position.

According to a favorable embodiment of the roller assembly, the roller set and the lifting bar with the floating plate may be mounted jointly on a rotating device. In this way, the roller set can be steered for a rolling test. This may take place in particular actively, in that the position of the wheels and/or of a steering wheel of the vehicle on the roller assembly is sensed and the rotating device is accordingly rotated.

According to a favorable embodiment of the roller assembly, the lifting bar may have a receiving unit on which the floating plate is mounted in a floating manner. In particular, the floating plate may form at least a part of a surface of the lifting bar.

The floating plate may take up the entire top side of the lifting bar. Alternatively, the top side may have a rigid segment which is adjoined by the floating plate in the direction of the transverse axis.

According to a favorable embodiment of the roller assembly, the receiving unit of the lifting bar may have at least one recess in which the floating plate engages with at least one guide peg. In particular, a boundary of the at least one recess may form a stop for rotation of the floating plate about the vertical axis. Thus, a rotational movement of the floating plate about the vertical axis can be limited in a simple manner.

According to a favorable embodiment of the roller assembly, the receiving unit may have at least one slot which extends in the direction of the transverse axis and in which the floating plate engages with a guide peg. In particular, a boundary of the slot may form a stop for displacement of the floating plate in the direction of the transverse axis. Thus, a translational movement of the floating plate in the direction of the transverse axis can be limited in a simple manner.

Advantageously, the slot may be arranged, in the direction of the transverse axis, between two recesses which form a stop for rotation of the floating plate about the vertical axis. In particular, the recesses and slot are arranged on a straight line in the direction of the transverse axis.

According to a favorable embodiment of the roller assembly, the floating plate may have at least one stop for securing a wheel on the floating plate in the direction of the longitudinal axis. In particular, the floating plate may have an indentation, the boundaries of which respectively form a stop in the direction of the longitudinal axis.

Advantageously, this may be provided on a roller assembly which is provided for a rear axle. Rather than an indentation, it is also possible for an elevation or a corresponding contour to be provided on the floating plate. The wheel is secured even with a relatively small height of the stop.

According to a favorable embodiment of the roller assembly, the rotating device may have a spindle lift cylinder for rotating the roller set and lifting bar about the vertical axis. Alternatively, the rotating device may have a toothing for rotating the roller set and lifting bar about the vertical axis. Alternatively, the rotating device may have a toothed belt for rotating the roller set and lifting bar about the vertical axis. An appropriate robust rotating device that is easy to handle can be created.

According to a favorable embodiment of the roller assembly, a displacement device may be provided, with which the support is displaceable with the roller set and the lifting bar in the direction of the longitudinal axis and of the transverse axis. By means of the displacement device, a track width adjustment can be carried out, with the aid of which the vehicle test stand can be adjusted to the track width of the vehicle to be tested. Moreover, by means of the displacement device, the position of the roller assembly and thus of the floating plate with respect to the vehicle or with respect to the wheel can be changed. As a result, the position of the lifting bar under the wheel of the vehicle can be changed such that either a rigid segment of the surface of the lifting bar is positioned under the wheel or the floating plate is positioned under the wheel.

According to a favorable embodiment of the roller assembly, the clear free space between the rollers may measure at least 100 mm, in particular at least 250 mm. Advantageously, the free space between the rollers can be coordinated with a typical wheel diameter of the vehicles to be tested thereon. In this case, the clear free space may be dimensioned such that the respective wheel rests stably on the rollers when the lifting bar has been lowered. In the case of a conventional passenger car, a favorable free space may be, for example, at least 100 mm, in particular at least 250 mm. In the case of a conventional commercial vehicle, the free space may favorably be, for example, between 300 mm and 400 mm. The floating plate may be large enough for the wheel of the vehicle to be placed safely thereon without being disturbed by the rollers on both sides.

Optionally, an adjustment device may be provided, with which the free space between the two rollers is able to be variably set. In this way, the roller assembly may be adapted to different wheel sizes.

According to a favorable embodiment of the roller assembly, an extent of the lifting bar along the longitudinal axis may measure at least 90 mm, in particular at least 100 mm. Expediently, the extent in the direction of the longitudinal axis may be chosen such that there is a sufficient tire contact area, such that the wheel of the vehicle to be respectively tested stands stably on the lifting bar and the lifting bar is movable up and down within the free space in a manner not disturbed by the rollers.

According to a favorable embodiment of the roller assembly, a drive unit for driving the roller set may be arranged in a stationary manner with respect to the roller set. Alternatively or additionally, a drive unit for driving the roller set may be arranged in a stationary manner with respect to the support.

In particular, in this case, the drive unit may be connected to the roller set by way of a coupling. If the lifting bar is rotated by means of the rotating device, the coupling can ensure the force transmission from the drive unit to the roller set. Alternatively or additionally, at least one of the rollers may have a roller motor, which directly drives the at least one roller. An appropriate arrangement and design of the drive unit can be chosen in each case.

According to a further aspect of examples disclosed herein, a vehicle test stand having at least one roller assembly is proposed, which is arranged in a track for receiving a vehicle, having an open-loop and/or closed-loop control unit for controlling components and/or for sensing sensor signals from sensor units present on the vehicle test stand.

In this case, the roller assembly comprises (a) a support; (b) a roller set, arranged on the support, with rollers that are arranged parallel to one another and form a horizontal wheel holder, wherein a lifting bar that is movable in the direction of the vertical axis is arranged in a clear free space between two of the rollers and the lifting bar has a floating plate on its top side.

Advantageously, a vehicle test stand is provided in which functions of two conventional test stands are combined, specifically the function of a rolling test stand and the function of a chassis test stand.

The testing of the vehicle on the vehicle test stand can proceed in an automated or partially automated manner. Advantageously, the open-loop and/or closed-loop control unit may have corresponding automation software, which comprises functionalities of plant control, management of the drive units of the respective roller set and of the displacement device of the respective roller assembly, and interface handling for the rolling test and for the chassis test. In particular, the open-loop and/or closed-loop control device may have a processor or a computer or be coupled to a computer, wherein the processor or the computer software has for operating the vehicle test stand for testing and adjusting a vehicle with at least one roller assembly and in order to carry out steps for operating the vehicle test stand in the different test phases.

It is favorable to provide a roller assembly for each wheel of the vehicle.

By means of measuring technology, in particular by means of contactless measuring technology, precise measurements of the chassis parameter, such as tow, camber, height of the vehicle, tracking, etc., can be caried out. Similarly, precise adjustment of the chassis parameters can be effected.

For precise measurement of the chassis geometry on the tire outer side, while simultaneously taking into consideration a so-called wheel runout, the vehicle wheels can be rotated uniformly. This takes place with the aid of driven roller pairs of the roller set.

The vehicle position may be measured, for example, with the aid of a laser measurement system, wherein measurement and positioning can take place with rotating wheels.

The vehicle can be positioned, in particular in a motor-controlled manner, by deflecting the roller assemblies with the lifting bar lowered, until the distance of the wheels from the measurement system is the same on both sides.

In order to hold the vehicle during adjustment, the floating plates may optionally also be equipped with corresponding brakes. These may prevent the vehicle from unintentionally moving out of a stable position on the roller assembly.

According to a favorable embodiment of the vehicle test stand, devices for directly or indirectly sensing rolling behavior and/or static or dynamic braking behavior of the vehicle may be provided. For example, indirect sensing may take place via converter data from the roller drive, for example the electric current through the drive unit of the rollers. Alternatively, force and/or torque sensors may also be used.

According to a favorable embodiment of the vehicle test stand, devices for directly or indirectly sensing a toe and camber angle, the track width and/or a chassis geometry and/or chassis parameters of the vehicle and/or a vehicle geometry may be provided. Advantageously, the height of the vehicle can be sensed on the vehicle, in particular the precise position of the highest point of the wheel arch edge and the like. For example, optical measuring systems may be used.

In particular devices may be provided which otherwise need to be provided separately in the case of a separate rolling test stand and chassis test stand. Thus, for example, an adjusting device for adapting the spacing of the roller assemblies to the wheel base of the vehicle needs to be provided only once, and ultrasonic sensors in the roller assembly for determining the vehicle position can be dispensed with.

According to a favorable embodiment of the vehicle test stand, an adjusting device for adapting the spacing of the roller assemblies to a wheel base may be provided. Thus, the roller assemblies, which are assigned to an axle of the vehicle, may be displaced in the direction of the longitudinal axis in the vehicle test stand in order to set the correct spacing of the roller assemblies in accordance with the actual wheel base of the vehicle.

According to a further aspect of examples disclosed herein, a method for operating a vehicle test stand for testing a vehicle and having at least one roller assembly is proposed, wherein the roller assembly has a support and a roller set, arranged on the support, with rollers which are arranged parallel to one another and form a horizontal wheel holder, and wherein a lifting bar that is movable in the direction of a vertical axis is arranged in a clear free space between two of the rollers. The vehicle is positioned in a drive-in position with at least one wheel of at least one of its axles between the rollers on the roller set via the lifting bar.

The vehicle test stand comprises at least one roller assembly, which is arranged in a track for receiving a vehicle, and an open-loop and/or closed-loop control unit for controlling components and/or for sensing sensor signals from sensor units present on the vehicle test stand.

In this case, the roller assembly comprises (a) a support; (b) a roller set, arranged on the support, with rollers that are arranged parallel to one another and form a horizontal wheel holder, wherein a lifting bar that is movable in the direction of the vertical axis is arranged in a clear free space between two of the rollers and the lifting bar has a floating plate on its top side.

In this way, the respective wheel can be positioned safely on the roller set and thus the vehicle can be positioned safely on the vehicle test stand. Upon rotation of the rollers, the roller assembly can be rotated about the vertical axis and the respective wheel can be positioned safely on the roller assembly.

According to a favorable embodiment of the method, to carry out a reversal measurement, the lifting bar may be lowered for the reversal measurement and the roller set may be set into rotational movement. In this case, the wheel rests on the rollers and is no longer in contact with the lifting bar. A reversal measurement, in which the orientation of the wheel can be sensed, is usually carried out at low speeds. Speeds of at most 5 km/h, preferably of at most 2 km/h, particularly preferably in the range of 1-2 km/h, are advantageous. Depending on the vehicle and desired precision, the speed may also be higher. At a higher speed, the demands for precision may usually be lower than at a lower speed.

According to a favorable embodiment of the method, for chassis adjustment, at least one wheel of the vehicle may be positioned on the roller set and stands on the floating plate of the raised lifting bar. Advantageously, the floating plate, as a result of its rotational and translational movability, allows the wheel axle to be free of stress when the wheels stand on the floating plate.

Advantageously, the floating plate may be arranged on an inner edge of the roller assembly. As a result, it is possible, for example, for the wheels of the vehicle to be positioned on an edge of the roller assembly, such that a worker has easier access to tie rods and the like on the wheel inner side.

According to a favorable embodiment of the method, for a rolling test, the wheel of the vehicle may be positioned on the roller set and the lifting bar may be lowered. In the lowered state, the lifting bar may be positioned and fixed in a defined position in the direction of the transverse axis. Advantageously, the rolling test can be carried out in a manner not disturbed by the lifting bar, since the wheel or the wheels are in contact only with the rollers with the lifting bar lowered.

According to a favorable embodiment of the method, the vehicle may be positioned in a drive-out position with its wheel on the roller set, and in the drive-out position the lifting bar may be raised. In this way, the vehicle can be removed from the roller set without problems in the longitudinal direction, in spite of the relatively large spacings between the rollers with the lifting bar arranged in between.

According to a further aspect of examples disclosed herein, a computer program product is proposed, comprising commands that cause a vehicle test stand according to examples disclosed herein, having at least one roller assembly according to examples disclosed herein, to carry out the steps of the method according to examples disclosed herein.

In particular, the following steps are carried out. In a drive-in position of the vehicle, a lifting bar of the roller assembly is raised between two rollers of a roller set of the roller assembly in the direction of a vertical axis, and a wheel of the vehicle is arranged on the roller set.

On the vehicle test stand, in order to selectively carry out a reversal measurement, the lifting bar is lowered with respect to the vertical axis and the roller set is set into rotational movement by a drive unit and the wheel is placed on the roller set. At the same time as the reversal measurement, vehicle positioning can also take place by rotation of the roller assembly about the vertical axis.

On the vehicle test stand, for selective chassis adjustment, a wheel of the vehicle is positioned on the roller set and stands on the floating plate of the raised lifting bar.

On the vehicle test stand, for the selective rolling test, the lifting bar is lowered and the rollers are set into rotational movement by a drive unit, wherein the roller set is rotated about the vertical axis as required.

In a drive-out position of the vehicle, the vehicle is positioned with its wheel on the roller set and with the lifting bar raised.

The position of the wheel on the roller set in the different steps of the method be central or off-center. Optionally, the wheel may, in the different steps of the method, be positioned deliberately centrally or off-center as required. To this end, the roller assembly may be displaced appropriately in the direction of the transverse axis.

Advantageously, an open-loop and/or closed-loop control unit of the vehicle test stand is designed to carry out the computer-implemented method. In particular, the open-loop and/or closed-loop control unit may have a computer-readable storage medium, which comprises commands which, when carried out by a computer of the open-loop and/or closed-loop control unit, cause it to carry out the steps of the method.

In this case, the vehicle test stand comprise at least one roller assembly, which is arranged in a track for receiving a vehicle, and an open-loop and/or closed-loop control unit for controlling components and/or for sensing sensor signals from sensor units present on the vehicle test stand.

The roller assembly in this case comprises (a) a support; (b) a roller set, arranged on the support, with rollers that are arranged parallel to one another and form a horizontal wheel holder, wherein a lifting bar that is movable in the direction of the vertical axis is arranged in a clear free space between two of the rollers and the lifting bar has a floating plate on its top side.

The vehicle may be driven into or out of the vehicle test stand in an automated manner, and lateral movements of the vehicle are compensated by rotation of the roller set about the vertical axis.

Alternatively, the vehicle may also be driven in or out manually, in that the vehicle is pushed or moved by its drive.

Also proposed is a computer program comprising commands that cause a vehicle test stand according to examples disclosed herein, having at least one roller assembly according to examples disclosed herein, to carry out the steps of the method according to examples disclosed herein.

Also proposed is a computer-readable medium on which the computer program is stored.

Advantageously, a vehicle test stand may be retrofitted with roller assemblies according to examples disclosed herein. The computer program product, the computer program and the computer-readable medium allow an open-loop and/or closed-loop control unit that is present to be adapted to the vehicle test stand retrofitted in this way.

### DRAWING

Further advantages will become apparent from the following description of the drawing. Exemplary embodiments of examples disclosed herein are illustrated in the figures. The figures, the description and the claims contain numerous features in combination. A person skilled in the art will expediently also consider the features individually and combine them to form appropriate further combination.

In the figures, by way of example:

FIG. 1 shows a vehicle test stand for a vehicle according to one exemplary embodiment of examples disclosed herein, in which there are four roller assemblies;

FIG. 2 shows a roller assembly with a lifting bar in detail according to one exemplary embodiment of examples disclosed herein;

FIG. 3 shows a detail view of the lifting bar of the roller assembly according to FIG. 2 with a positioning device of the lifting bar for a lowered state of the lifting bar;

FIG. 4 shows a cutaway illustration of the detail view in FIG. 3;

FIG. 5 shows a plan view of a detail of the lifting bar from FIG. 2 with the floating plate removed;

FIG. 6 shows a side view of a lifting bar with a concave floating plate according to one exemplary embodiment of examples disclosed herein;

FIG. 7 shows a roller assembly according to one exemplary embodiment of examples disclosed herein with a vehicle indicated;

FIG. 8 shows a view of a vehicle on a roller assembly according to one exemplary embodiment of examples disclosed herein with a central positioning;

FIG. 9 shows a view of a vehicle on a roller assembly according to one exemplary embodiment of examples disclosed herein with lateral position, with a roller assembly displaced in the direction of the transverse axis;

FIG. 10 shows an illustration of a vehicle in a drive-in position with one wheel on the lifting bar;

FIG. 11 shows an illustration of a vehicle with one wheel in position for a reversal measurement with the lifting bar lowered;

FIG. 12 shows an illustration of a vehicle with one wheel in position for chassis adjustment with the wheel on a floating plate of the raised lifting bar;

FIG. 13 shows an illustration of a vehicle with one wheel in a central position for a rolling measurement with the lifting bar lowered;

FIG. 14 shows an illustration of a vehicle in a drive-out position with one wheel on the raised lifting bar;

FIG. 15 shows an arrangement of a drive unit of a roller set according to one exemplary embodiment of examples disclosed herein, in which the drive unit rotates about the vertical axis when the roller set is steered;

FIG. 16 shows another view of the arrangement of the drive unit according to FIG. 15;

FIG. 17 shows an arrangement of a drive unit of a roller set according to one exemplary embodiment of examples disclosed herein, in which the drive unit is stationary about the vertical axis when the roller set is steered, and is connected to the roller set via a cardan shaft;

FIG. 18 shows another view of the arrangement of the drive unit according to FIG. 17;

FIG. 19 shows an arrangement of a drive unit of a roller set according to one exemplary embodiment of examples disclosed herein, in which the drive unit rotates about the vertical axis when the roller set is steered;

FIG. 20 shows an arrangement of a drive unit of a roller set according to one exemplary embodiment of examples disclosed herein, in which the drive unit is stationary about the vertical axis when the roller set is steered, and is connected to the roller set via a cardan shaft;

FIG. 21 shows a view in partial section of a rotating device having a rotating plate according to one exemplary embodiment of examples disclosed herein with a spindle lift cylinder;

FIG. 22 shows an isometric illustration of the rotating plate according to FIG. 21;

FIG. 23 shows a view in partial section of a rotating device having a rotating plate according to one exemplary embodiment of examples disclosed herein with rotation via a pairing of a pairing and an internal toothing of the rotating plate.

### DETAILED DESCRIPTION

In the figures, identical or identically acting components are provided with the same reference signs. The figures show only examples and should not be understood as being limiting.

Before examples disclosed herein are described in detail, it should be noted that it is not limited to the respective components of the device and the respective method steps, since these components and methods can vary. The terms used herein are intended only to describe particular embodiments and are not used in a limiting manner. Moreover, when the singular or the indefinite article is used in the description or in the claims, this also refers to the plurality of these elements, unless the general context clearly makes something else clear.

Directional terminology used in the following text with terms such as “left”, “right”, “top”, “bottom”, “in front”, “behind”, “after” and the like serves merely to make the figures easier to understand and is not intended to represent a restriction of the generality in any way. The illustrated components and elements, and the design and use thereof can vary as considered by a person skilled in the art and can be adapted to the respective applications.

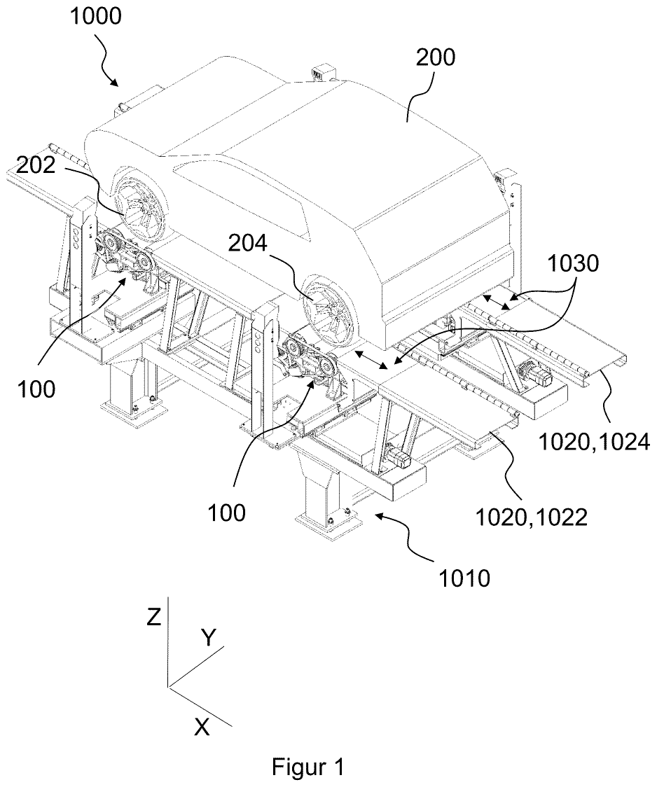

FIG. 1 shows, to explain examples disclosed herein, a vehicle test stand 1000 for a vehicle 200 according to one exemplary embodiment of examples disclosed herein, in which there are four roller assemblies 100, on which wheels 202 of the front axle and wheels 204 of the rear axle of the vehicle have been placed.

The vehicle test stand 1000 and the respective roller assembly 100 have a vertical axis Z, a transverse axis Y, and a longitudinal axis X. The vehicle test stand 1000 has a base frame 1010, on which in each case two of the four roller assemblies 100 are arranged in a track 1020, which in this example has two mutually parallel sides 1022, 1024, between which there is a free space, in which a worker has access to a chassis of the vehicle 200.

In particular, as a result, the inner side of the wheels 202, 204 is accessible, in the vicinity of which the vehicle usually has tie rods, which are thus more easily accessible in order to adjust the chassis.

Provided in the track 1020 is an adjusting device 1030 for adapting the spacing of the roller assemblies 100 to the wheel base of the vehicle 200. For example, the two roller assemblies 100 that are associated with the rear axle can be displaced in the direction of the longitudinal axis X in the vehicle test stand in order to set the correct spacing of the roller assemblies 100 under the front axle and the rear axle in accordance with the actual wheel base of the vehicle 200. The device 1030 for adapting the spacing can be telescopically introduced into or pulled out of respective side 1022, 1024 of the track 1020. To this end, elements that can pass into or out of the respective side of the track 1020 are provided in front of and behind the respective roller assembly 100.

Furthermore, devices that are not illustrated are provided, with which appropriate measurements can be taken on the vehicle 200. The devices are connected to an open-loop and/or closed-loop control unit, in which measured values can be received and processed. Similarly, the open-loop and/or closed-loop control unit can control a drive unit associated with the respective roller assembly 100 and/or a rotating device of the respective roller assembly 100. Furthermore, the open-loop and/or closed-loop control unit may contain a computer program, which contains commands with which, in particular, the roller assemblies 100 that are provided can behave in a particular way.

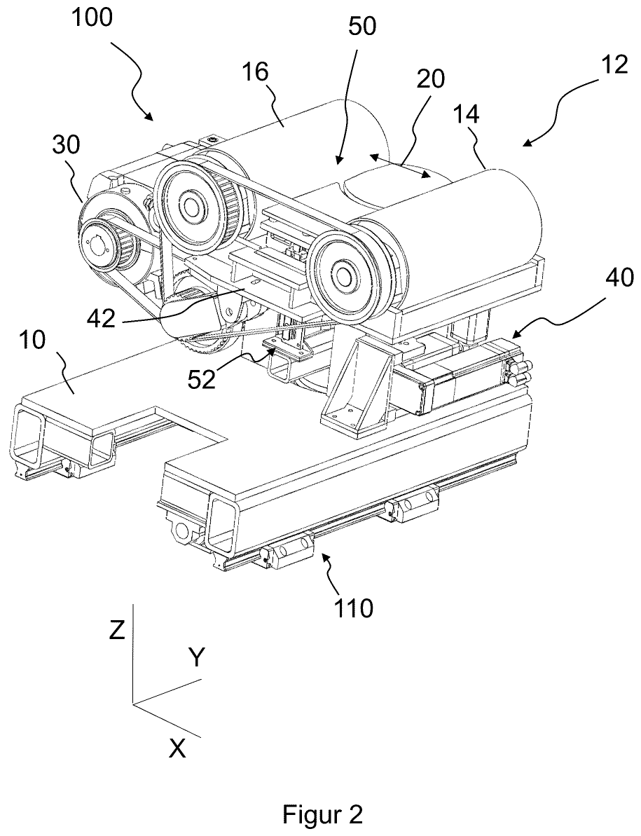

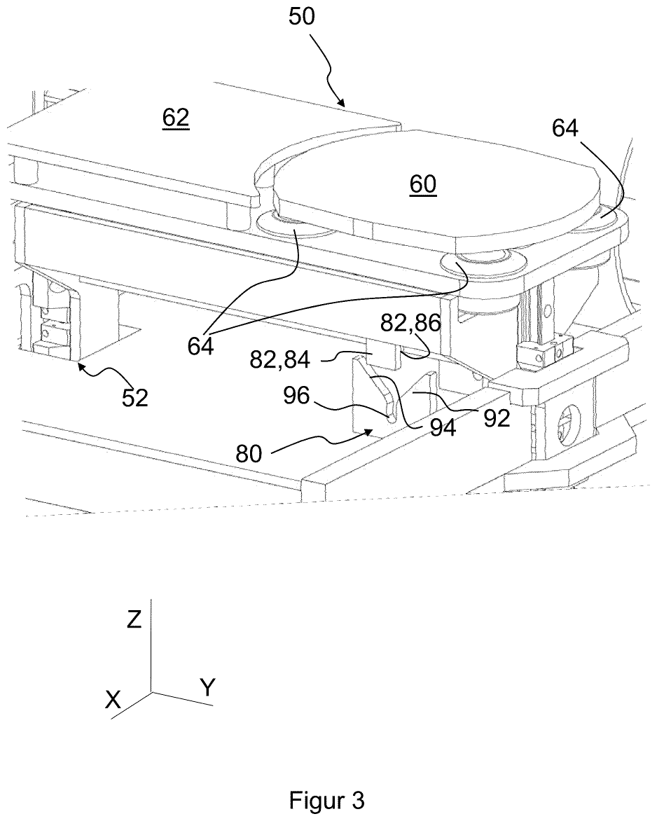

FIG. 2 shows a roller assembly 100 having a lifting bar 50 in detail according to one exemplary embodiment of examples disclosed herein. FIGS. 3 to 5 show different view and details of the lifting bar 50.

The roller assembly 100 comprises a roller set 12 with identical, in this case two, rollers 14, 16 that are arranged with their axes of rotation parallel to one another and can be driven by a drive unit 30. The two rollers 14, 16 are spaced apart from one another by a clear free space 20. The clear free space 20 between the rollers 14, 16 is dimensioned such that a wheel of a vehicle is positioned safely on the rollers 14, 16 with the lifting bar 50 lowered, and with the lifting bar 50 raised there is a sufficient wheel contact area on the lifting bar 50. For passenger cars, a favorable clear free space 20 is at least 100 mm, in particular at least 250 mm, and for trucks for example between 300 mm and 400 mm. The extent of the lifting bar 50 in the direction of the longitudinal axis X measures, for example, 250 mm.

Arranged in the clear free space 20, between two of the rollers 14, 16, in this case the two rollers 14, 16, is the lifting bar 50, which is movable in the direction of the vertical axis Z. On its top side, the lifting bar 50 has a floating plate 60. The lifting bar 50 substantially fills the clear free space 20 but can be moved up and down in the direction of the vertical axis Z between the two rollers 14, 16 without coming into contact with the rollers 14, 16 arranged on both sides. In this exemplary embodiment, the lifting bar 50 has the floating plate 60 on its top side and, alongside, a rigid segment 62. Optionally, provision may be made for the top side to be formed overall by a floating plate 60. The floating plate 60 can be arranged off-center, in particular on one side of the lifting bar 50, for instance on the inner side toward the free space between the sides 1022, 1024 of the track 1020, or be arranged centrally in the lifting bar 50.

As a result of the extent, adapted to the free space 20, of the lifting bar 50 in the direction of the longitudinal axis X, a wheel 202, 204 of a vehicle 200 (FIG. 1) can stand without problems on the lifting bar 50 when the latter is in its raised position, without the wheel 202, 204 coming into contact with the rollers 14, 16 on both sides of the lifting bar 50. Thus, with the lifting bar 50 raised, the chassis of the vehicle 200 can be adjusted, while, with the lifting bar 50 lowered, the respective wheel 202, 204 of the vehicle 200 sits on the rollers 14, 16 and can rotate when these are driven by the drive unit 30. A lifting drive 52 serves for raising and lowering the lifting bar 50.

In this state, a reversal measurement can take place at a low speed, during which a camber or other geometric property of the wheel 202, 204 can be sensed, or a rolling measurement can take place, in which considerably higher speeds can be applied and the wheels 202, 204 of the steered axle can be steered as required.

As a result of the large spacing of the two rollers 14, 16, the vehicle 200 can driven into the roller assembly 100 or out of the roller assembly 100 only when the lifting bar 50 is in its raised position.

The roller assembly 100 also has a support 10, on which the roller set 12 is arranged. In this case, the roller set 12 is arranged with the lifting bar 50 on a rotating device 40, in particular a turntable 42, in order to rotate or pivot the roller set 12 with the lifting bar 50 about the vertical axis Z.

To rotate the roller set 12 with the lifting bar 50 about the vertical axis Z, the rotating device 40 can have a spindle lift cylinder, an internal toothing or a toothed belt.

The support 10 has a displacement device 110, for example a lift cylinder or a spindle drive or the like, with which the roller assembly 100 can be moved back and forth in the direction of the transverse axis Y during use. To this end, the support 10 can be arranged on a base frame 1010 (FIG. 1) and be moved relative to the latter in the direction of the transverse axis Y.

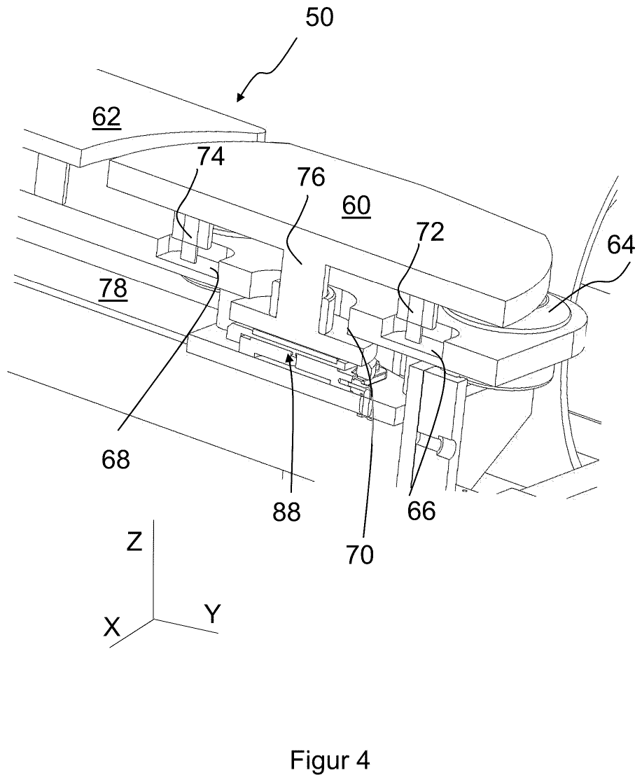

FIGS. 3 to 5 show views of the lifting bar 50 of the roller assembly 100 according to FIG. 2. FIG. 3 shows a positioning device 80 of the lifting bar 50 for a lowered state of the lifting bar 50. FIG. 4 shows a cutaway illustration of the detail view from FIG. 3. FIG. 5 shows a plan view of a detail of the lifting bar 50 from FIG. 2 with the floating plate 60 removed.

In this exemplary embodiment, the lifting bar 50 has, on its top side, a floating plate 60 and, alongside, a rigid segment 62, these being arranged on a receiving unit 78. The floating plate 60 is mounted in a floating manner on the receiving unit 78, for example on four balls 64.

In the direction of the transverse axis Y, the floating plate 60 has convexly rounded sides, while the rigid segment 60 has, on its side facing the floating plate 60, a corresponding concave indentation. During a rotation about the vertical axis Z on the receiving unit 78, the floating plate 60 can accordingly rotate freely.

In this exemplary embodiment, the receiving unit 78 has two recesses 66, 68, in which the floating plate 60 engages with guide pegs 72, 74 arranged on its underside. The guide pegs 72, 74 can move within the recesses 66, 68.

In this case, the respective boundary 67, 69 of the recesses 66, 68 forms a stop for rotation of the floating plate 60 about the vertical axis Z.

Furthermore, the receiving unit 78 has a slot 70 which extends in the direction of the transverse axis Y and in which the floating plate 60 engages with a guide peg 76 arranged on its underside. The boundary 71 of the slot 70 forms a stop for displacement of the floating plate 60 in the direction of the transverse axis Y. At the same time, the guide peg 76 forms an axis of rotation in the direction of the vertical axis Z for the floating plate 60, about which the floating plate 60 can rotate in any position of its guide peg 76 in the slot 70. The guide peg 76 is mounted on a braking device 88 with a flat cylinder, which can brake a movement of the floating plate 60.

The floating plate 60 allows a vehicle 200 (FIG. 1) to be able to stand on the lifting bar 50 with an unstressed axle, such that measurements and adjustments can be performed on the chassis of the vehicle 200.

Also provided is a positioning device 80 (FIG. 3), which centers and/or fixes the lifting bar 50 in a lowered state at least in the direction of the transverse axis Y. The positioning device 80 has a first positioning element 82, for example on the receiver 78 of the lifting bar 50, and a second positioning element 90, for example on a mount of the rollers 14, 16.

The first positioning element 82 has a tab 84 that projects toward the second positioning element 92 and from which a guide peg 86 protrudes in the direction of the longitudinal axis X. In FIG. 3, the peg 86 projects into the plane of the drawing and is indicated by a broken circle.

The second positioning element 92 has a control surface 94, which extends in a V-shaped manner. Arranged at the minimum of the V-shaped control surface 94 is a groove 96. While the lifting bar 50 is being lowered, the peg 86 of the first positioning element 82 slides on the control surface 94 in the direction of the groove 96 and catches in the groove 96. As a result of this forced guidance, the lifting bar 50 can be easily moved into and held in a defined position during the lowering process.

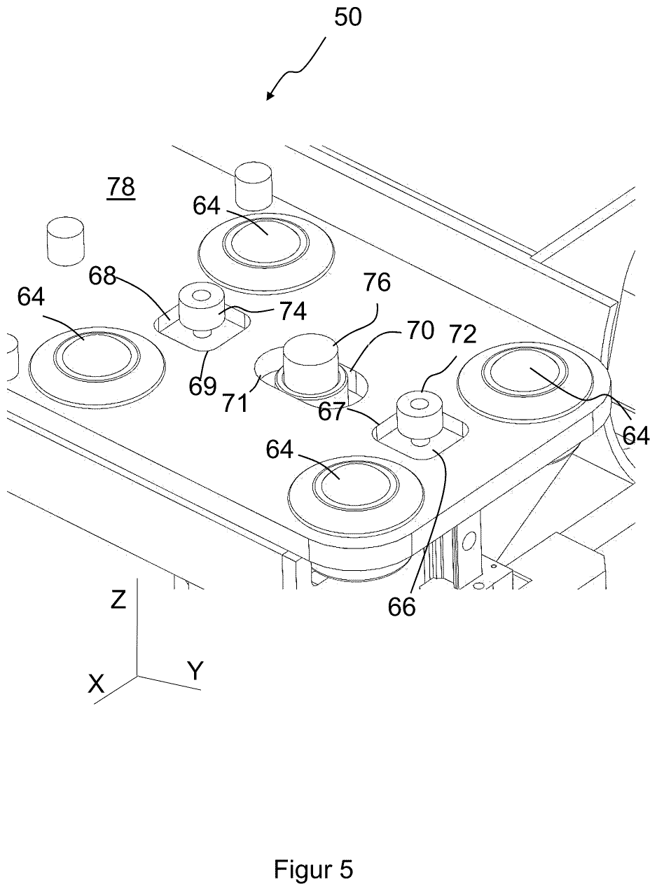

FIG. 6 illustrates a side view of a variant of the lifting bar 50 according to one exemplary embodiment of examples disclosed herein, which shows a floating plate 60 with a concave indentation 61 in its surface. The concave indentation 61 extends in the direction of the longitudinal axis X and makes it easy to fix a wheel on the floating plate 50 in the direction of the longitudinal axis X. The edges of the concave indentation 61 each represent a threshold that the wheel cannot readily overcome by chance.

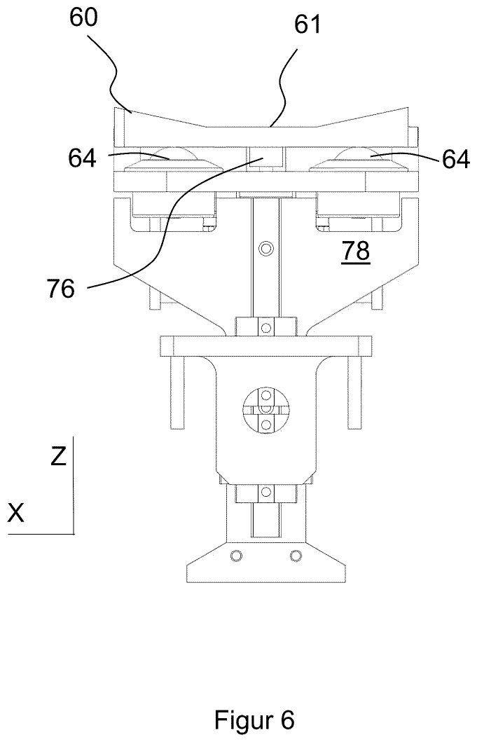

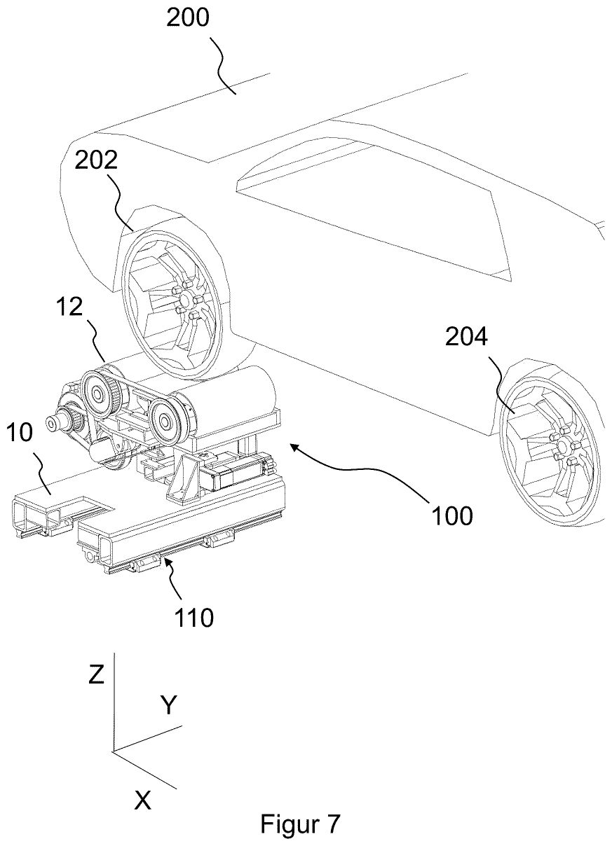

FIGS. 7 to 9 each show a detail view of a single roller assembly 100 with a wheel 202, arranged thereon, of a vehicle 200. FIG. 7 shows an isometric view with the wheel 202 in, for example, a central position on the roller set 12 with the lifting bar 50 lowered. In this position, the wheel is in contact with the roller set 12 and can be driven indirectly by a drive unit 300 that drives the roller set 12. FIG. 8 shows this position in the form of a rear view. FIG. 9 shows a rear view in which the roller assembly 100 has been displaced outward in the direction of the transverse axis Y. This takes place by means of the displacement device 110. As a result, the wheel 202 is positioned on the inner edge of the roller set 12 and can stand on the floating plate 60 (FIGS. 2, 3). If the two wheels 202 of an axle are positioned on the respective floating plate 60, this is free of stress, and so it is possible to adjust the chassis, for example the tie rod.

The positioning on the inner edge of the roller set 12 and accordingly of the roller assembly 100 makes it easier for a worker, for example, to access the tie rods closely adjacent to the inner side of the wheels.

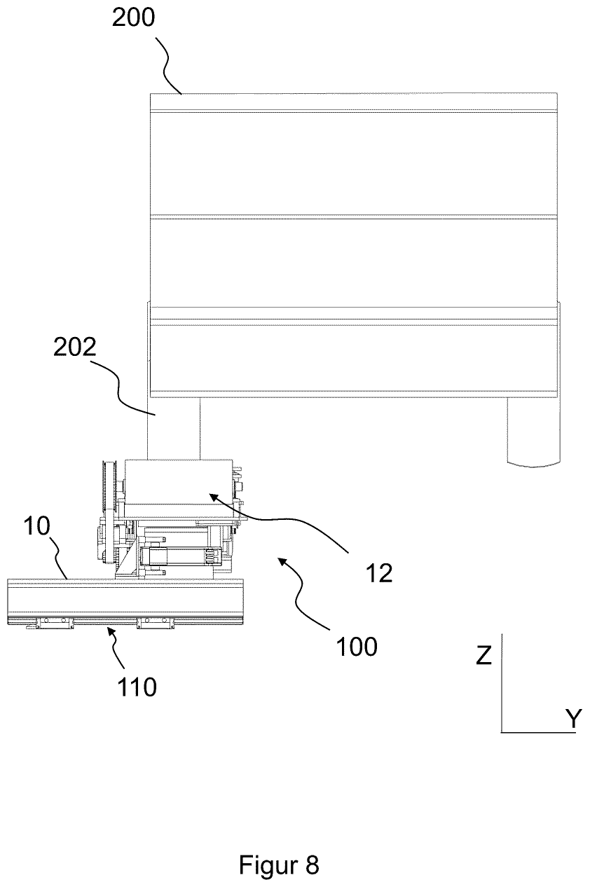

FIGS. 10 to 14 show, in the form of side views, the position in the direction of the vertical axis Z of a wheel 202 of a vehicle (not illustrated in more detail) on the roller set 12 of a roller assembly (not illustrated in more detail).

FIG. 10 shows an illustration of a drive-in position with a wheel 202 on the lifting bar 50, which is arranged in the clear free space 20 between the rollers 14, 16. In the drive-in position, the lifting bar 50 is in a raised position such that the wheel 202, on being driven in, can stop easily between the rollers 14, 16 on the lifting bar 50. The lifting bar 50 has been raised in the direction of the vertical axis Z such that it does not protrude beyond the roller set 12. The roller set 12 and thus the roller assembly are in, for example, a central position with regard to the transverse axis Y. In this illustration, the latter is oriented perpendicularly to the plane of the drawing. In the central position, the wheel 202 can stand on a rigid segment 62 (FIGS. 2, 3) of the lifting bar 50 when the floating plate 60 is arranged off-center.

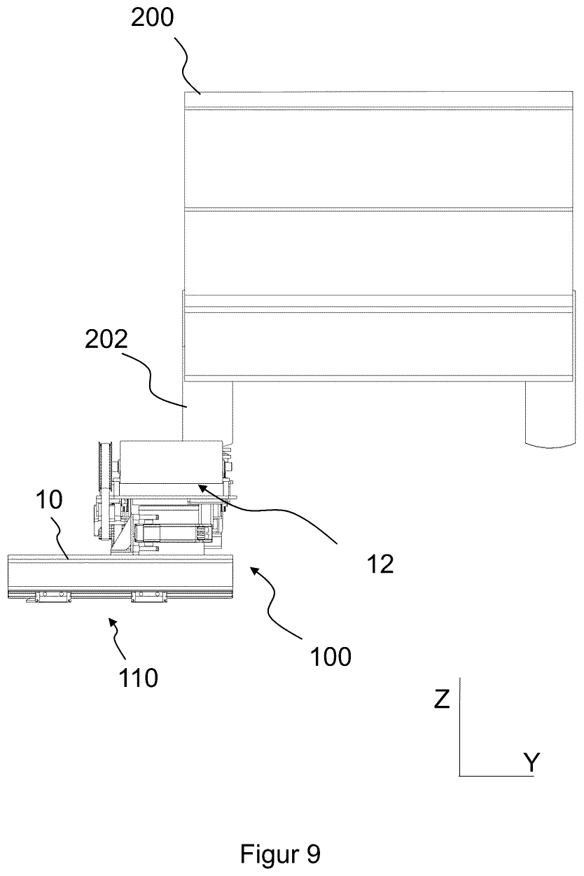

FIG. 11 shows an illustration with a wheel 202 in position for a reversal measurement with the lifting bar 50 lowered. The wheel 202 sits on the two rollers 14, 16 and can be driven thereby. During a reversal measurement, low speeds are favorable, which can advantageously lie in the range of 1-2 km/h.

FIG. 12 shows an illustration with a wheel 202 in position for chassis adjustment. In this case, the wheel 202 has been placed on a floating plate 60 (FIGS. 2, 3) of the raised lifting bar 50. The lifting bar 50 has been raised to such an extent that the wheel 202 is no longer in contact with the rollers 14, 16, but is standing fully on the lifting bar 50.

In order that the wheel 202 can stand on the floating plate 60 and not on the rigid segment 62 (FIGS. 3, 4), the roller assembly (not illustrated), as described in FIG. 9, has been displaced accordingly in the direction of the transverse axis Y, which is oriented perpendicularly to the plane of the drawing in the illustration.

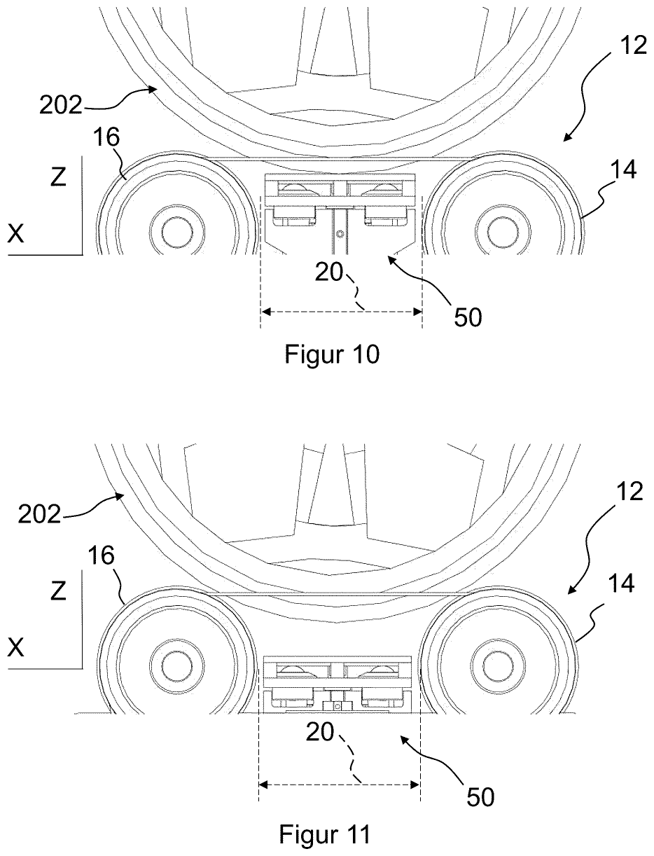

FIG. 13 shows an illustration with a wheel 202 in, for example, a central position on the roller set 12 for a rolling measurement with the lifting bar 50 lowered. The wheel 202 sits on the two rollers 14, 16 and can be driven thereby. During the rolling measurement, higher speeds, for example 80-90 km/h or more, are favorable.

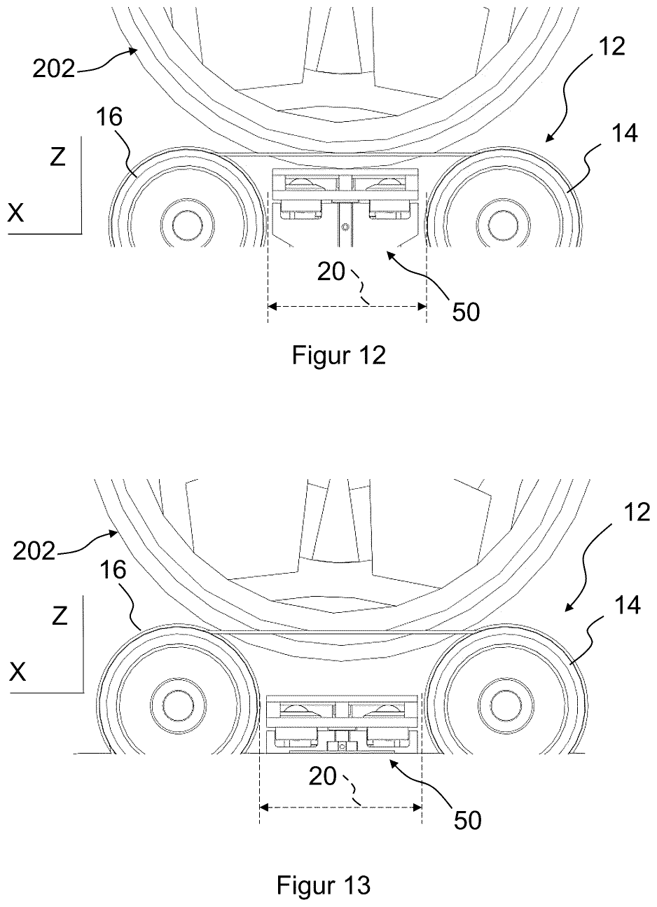

FIG. 14 shows an illustration of a drive-out position with a wheel 202 on the raised lifting bar 50. The wheel 202 sits on the rigid segment 62 (FIGS. 3, 4) of the lifting bar 50 and can easily drive out over one of the rollers 14, 16 in the direction of the longitudinal axis X.

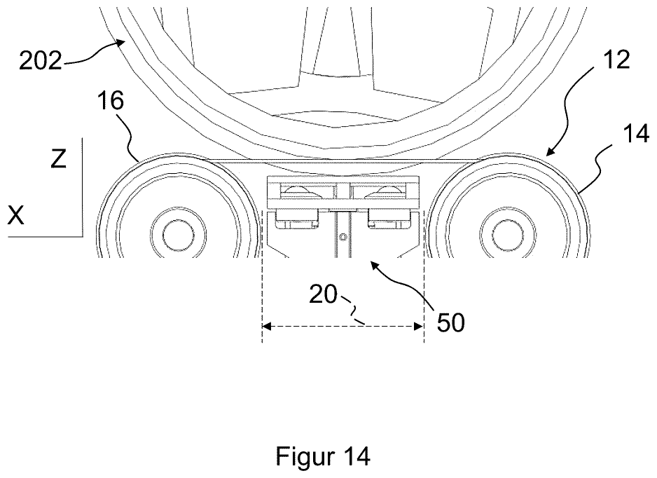

FIGS. 15 to 18 show different arrangements of a drive unit 30 of the roller set 12 with regard to a rotating device 40 of a roller assembly (not illustrated in more detail).

Advantageously, the wheel-alignment stand function is integrated into the lifting bar 50. The floating plate 60, which is integrated into the lifting bar 50, is a smaller floating plate 60 compared with the prior art. The adjustment and measurement of chassis properties take place in the lifted state on the floating plate 60 or lifting bar 50.

FIGS. 15 and 16 show different views of an arrangement of the drive unit 30 in which, when the roller set 12 is steered, the drive unit 30 rotates about the vertical axis Z with the roller set 12 when the rotating device 40, for example a turntable 42, rotates about the vertical axis Z.

In this case, via a belt, for example a V-belt or a toothed belt, the drive unit 30 drives a gearwheel 32, which in turn drives the two rollers 14, 16 via a further belt, for example a V-belt or a toothed belt, which connects the two rollers 14, 16 and the gearwheel 32.

Advantageously, this may be a scaled rolling test stand, in which speeds of the roller set 12 of, for example, 90 km/h are provided. The rotation about the vertical axis Z serves for the steering movement of the roller set 12, wherein the drive unit 30 corotates since it is fastened in the rotatable region of the arrangement.

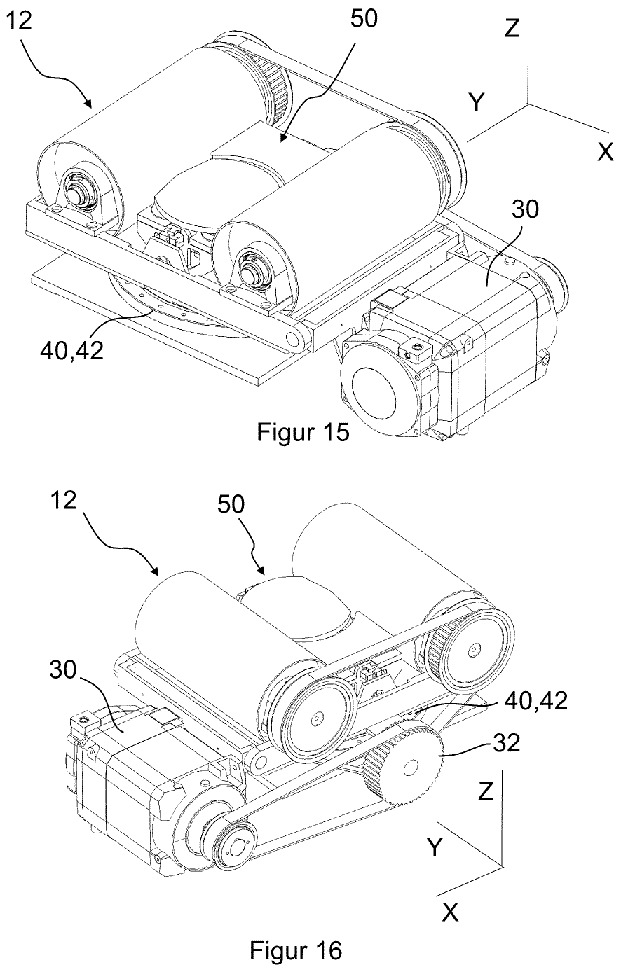

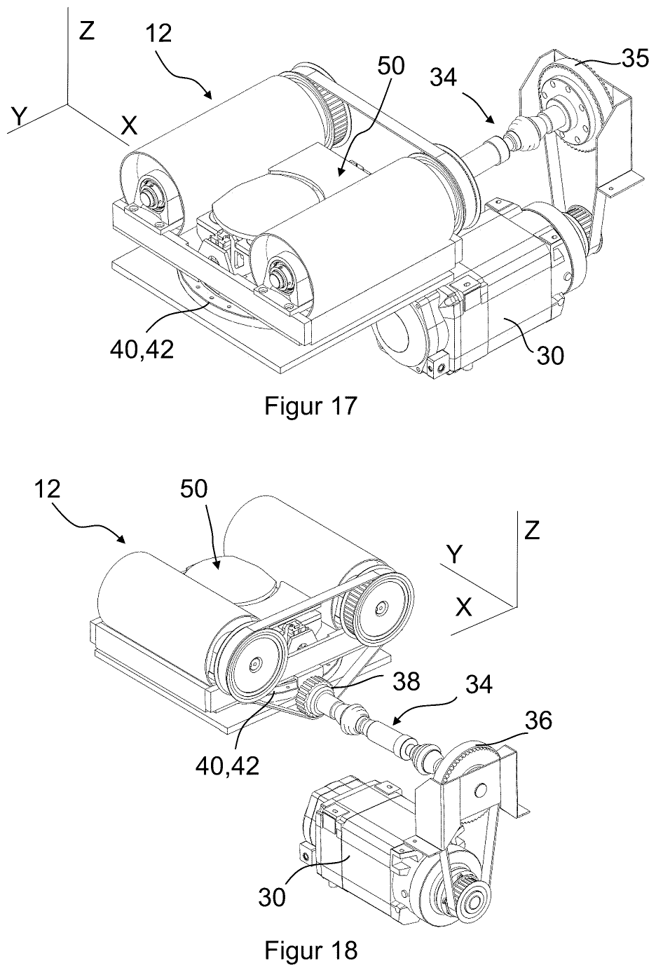

FIGS. 17 and 18 show different views of an arrangement of a drive unit 30 of a roller set 12 according to one exemplary embodiment of examples disclosed herein, in which the drive unit 30 is stationary about the vertical axis Z when the roller set 12 is steered, and is connected to the roller set 12 via a cardan shaft 34. The cardan shaft 34 allows compensation of the rotation of the roller set 12 about the vertical axis Z with respect to the drive 30. The cardan shaft 34 has a gearwheel 36, 38 on each of its two sides. In this case, one gearwheel 36 is connected to the drive unit 30 via a belt. The other gearwheel 38 drives the two rollers 14, 16 via a belt, which runs around the two end-side gearwheels of the rollers 14, 16. The belt can in each case be in the form, for example, of a V-belt or toothed belt.

Advantageously, this may be a scaled rolling test stand, in which speeds of the roller set 12 of, for example, 90 km/h are provided. The rotation about the vertical axis Z serves for the steering movement of the roller set 12, wherein the drive unit 30 does not corotate. The cardan shaft 34 can compensate the relative movement. The output is stationary in this case.

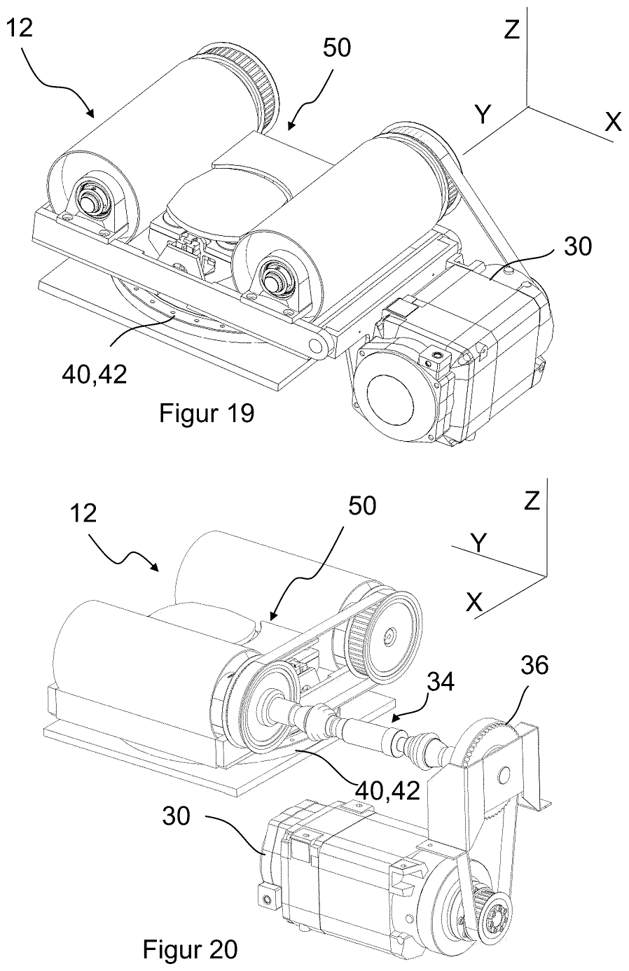

FIG. 19 shows an arrangement of a drive unit 30 of a roller set 12 in which the drive unit 30 corotates about the vertical axis Z when the roller set 12 is steered. In this case, only one of the rollers 14, 16 is driven. In this case, the drive unit 30 drives an end-side gearwheel of the one driven roller 14 or 16. The other of the rollers 16 or 14 is driven, during operation, by the wheel, placed thereon, of the vehicle (not illustrated).

Advantageously, this may be a scaled rolling test stand, in which speeds of the roller set 12 of, for example, 90 km/h are provided. The rotation about the vertical axis Z serves for the steering movement of the roller set 12, wherein the drive unit 30 corotates. The drive unit 30 is fastened in the rotatable region of the arrangement.

FIG. 20 shows an arrangement of a drive unit 30 of a roller set 12 in which the drive unit 30 is stationary about the vertical axis Z when the roller set 12 is steered, and is connected to the roller set 12 via a cardan shaft 34. The drive unit 30 in this case drives, via a belt, an end-side gearwheel 36 of the cardan shaft 34, for example with a V-belt or toothed belt. The cardan shaft 34 in turn is connected directly to one of the rollers 14 or 16, in particular to a shaft of this roller 14 or 16. The other roller 16 or 14 is driven via a belt which connects the two rollers 14, 16. The belt may be in the form, for example, of a V-belt or toothed belt.

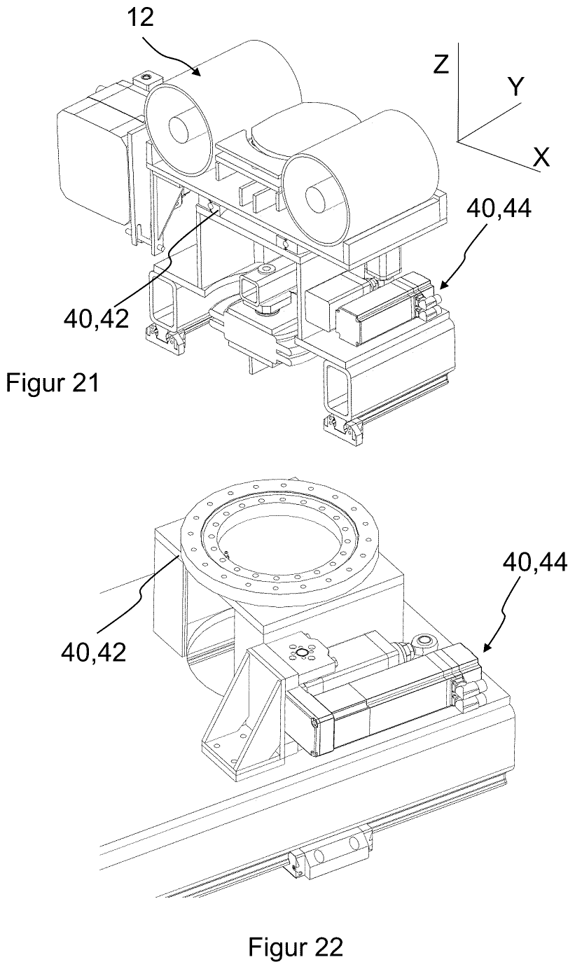

FIGS. 21 to 23 show different configurations of the rotating device 40.

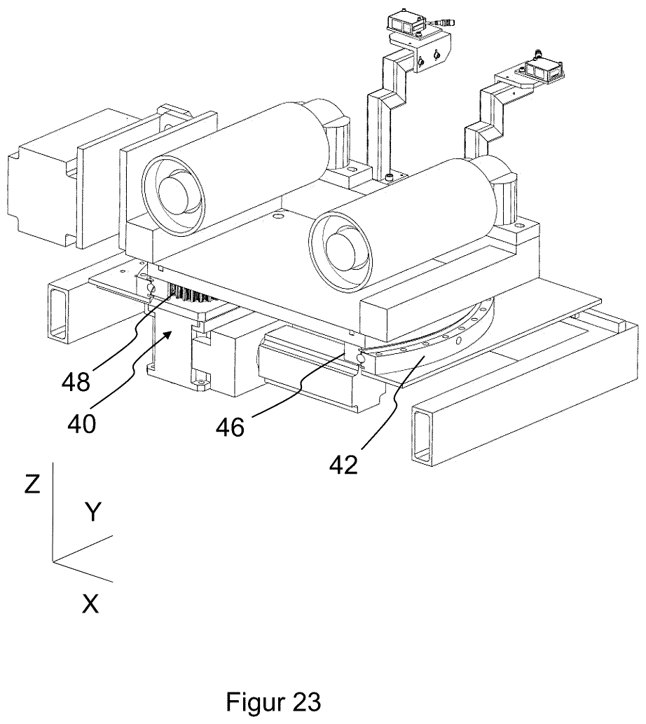

FIG. 21 shows a view in partial section of a rotating device 40 having a turntable 42 according to one exemplary embodiment of examples disclosed herein. FIG. 22 shows an isometric illustration of the turntable 42 according to FIG. 21. Rotation takes place via a spindle lift cylinder 44. If the spindle lift cylinder 44 is deflected, this is converted into a rotation of the turntable 42.

FIG. 23 shows a view in partial section of a rotating device 40 having a turntable 42 according to one exemplary embodiment of examples disclosed herein. The turntable 42 has an internal toothing 46. A driven pinion 48 can engage in the internal toothing 46 and set the turntable 42 in rotation.

In a method according to examples disclosed herein for operating a vehicle test stand 1000 for testing a vehicle 200, having at least one roller assembly 100, when the vehicle 200 is in a drive-in position, the vehicle 200 is positioned with its wheels 202, 204 centrally on the roller set 12 with the lifting bar 50 raised.

To carry out a reversal measurement, according to the method, the vehicle 200 is positioned with its wheel 202, 204 for example centrally or off-center on the roller set 12, the lifting bar 50 is lowered, and the roller set 12 is set in rotation.

For chassis adjustment, according to the method, the roller assembly 100 is displaced in the direction of the transverse axis Y such that at least one wheel 202, 204 of the vehicle 200 is positioned off-center on the roller set 12 and stands on the floating plate 6 of the raised lifting bar 50. As a result of the wheel 202, 204 being positioned off-center, the respective tie bar on the wheel inner side is more readily accessible.

For a rolling test, according to the method, the roller assembly 100 is displaced in the direction of the transverse axis Y such that the wheel 202, 204 of the vehicle 200 is positioned centrally on the respective roller set 12, wherein the lifting bar 50 is lowered for the rolling test.

For a drive-out position, according to the method, the roller assembly 100 is displaced in the direction of the transverse axis Y such that the vehicle 200 is positioned in a drive-out position with its wheel 202, 204 centrally on the respective roller set 12, wherein, in the drive-out position, the lifting bar 50 is raised.

The central or off-center position of the wheel 202, 204 can be selected freely in each case as required.

### REFERENCE SIGNS

10 Support
12 Roller set
14 Roller
16 Roller
20 Free space
30 Drive unit
32 Gearwheel
34 Cardan shaft
36 Gearwheel
38 Gearwheel
40 Rotating device
42 Turntable
44 Spindle lift cylinder
46 Internal toothing
48 Pinion
50 Lifting bar
52 Lifting drive of lifting bar
60 Floating plate
61 Indentation
62 Rigid segment
64 Ball
66 Recess
68 Recess
70 Slot
72 Guide peg
74 Guide peg
76 Guide peg
78 Receiving unit
80 Positioning device
82 Positioning element
84 Tab
86 Peg
92 Positioning element
94 Control surface
96 Groove
100 Roller assembly
110 Displacement device of support
200 Vehicle
202 Wheel
204 Wheel
1000 Vehicle test stand
1010 Base frame
1020 Track
1022 Side
1024 Side
1030 Adjusting device

1. A roller assembly for a vehicle test stand, having a vertical axis, a transverse axis and a longitudinal axis, the roller assembly comprising
a support; and
a roller set, arranged on the support, with rollers that are arranged parallel to one another and form a horizontal wheel holder,
wherein a lifting bar that is movable in the direction of the vertical axis is arranged in a clear free space between two of the rollers and the lifting bar has a floating plate on its top side.

2. The roller assembly as claimed in claim 1, wherein a positioning device is provided, which guides the lifting bar, in a lowered state, at least in the direction of the transverse axis into a home position and/or secures it in a home position.

3. The roller assembly as claimed in claim 1, wherein the roller set and the lifting bar with the floating plate are mounted jointly on a rotating device.

4. The roller assembly as claimed in claim 1, wherein the lifting bar has a receiving unit on which the floating plate is mounted in a floating manner, in particular wherein the floating plate forms at least a part of a surface of the lifting bar.

5. The roller assembly as claimed in claim 4, wherein the receiving unit of the lifting bar has at least one recess in which the floating plate engages with at least one guide peg, in particular wherein a boundary of the at least one recess forms a stop for rotation of the floating plate about the vertical axis.

6. The roller assembly as claimed in claim 4, wherein the receiving unit has at least one slot which extends in the direction of the transverse axis and in which the floating plate engages with a guide peg, in particular wherein a boundary of the slot forms a stop for displacement of the floating plate in the direction of the transverse axis.

7. The roller assembly as claimed in claim 1, wherein the floating plate has at least one stop for securing a wheel on the floating plate in the direction of the longitudinal axis, in particular wherein the floating plate has an indentation.

8. The roller assembly as claimed in claim 3, wherein the rotating device has a spindle lift cylinder for rotating the roller set and lifting bar about the vertical axis, or wherein the rotating device has a toothing for rotating the roller set and lifting bar about the vertical axis, or wherein the rotating device has a toothed belt for rotating the roller set and lifting bar about the vertical axis.

9. The roller assembly as claimed in claim 1, wherein a displacement device is provided, with which the support is displaceable with the roller set and the lifting bar in the direction of the transverse axis.

10. The roller assembly as claimed in claim 1, wherein the clear free space between the rollers measures at least 100 mm, in particular at least 250 mm.

11. The roller assembly as claimed in claim 1, wherein the extent of the lifting bar along the longitudinal axis measures at least 90 mm, in particular at least 100 mm.

12. The roller assembly as claimed in claim 1, wherein a drive unit for driving the roller set is arranged in a stationary manner with respect to the roller set, and/or wherein a drive unit for driving the roller set is arranged in a stationary manner with respect to the support, in particular is connected to the roller set by way of a coupling, and/or wherein at least one of the rollers has a roller motor.

13. A vehicle test stand having at least one roller assembly as claimed in claim 1, which is arranged in a track for receiving a vehicle, having an open-loop and/or closed-loop control unit for controlling components and/or for sensing sensor signals from sensor units present on the vehicle test stand.

14. The vehicle test stand as claimed in claim 13, wherein at least one device for directly or indirectly sensing rolling behavior and/or static or dynamic braking behavior of the vehicle is provided.

15. The vehicle test stand as claimed in claim 13, wherein at least one device for directly or indirectly sensing a toe and camber angle, the track width and/or for directly or indirectly sensing a chassis geometry and/or chassis parameters of the vehicle and/or a vehicle geometry is provided.

16. The vehicle test stand as claimed in claim 12, wherein an adjusting device for adapting a spacing of the roller assemblies to a wheel base of a vehicle is provided.

17. A method for operating a vehicle test stand as claimed in claim 13, the method comprising testing and/or adjusting a vehicle, the vehicle test stand having at least one roller assembly,
wherein the roller assembly has a support and a roller set, arranged on the support, with rollers which are arranged parallel to one another and form a horizontal wheel holder, and wherein a lifting bar that is movable in the direction of a vertical axis is arranged in a clear free space between two of the rollers and the lifting bar has a floating plate on its top side,
wherein the vehicle is positioned in a drive-in position with at least one wheel of at least one of its axles between the rollers on the roller set via the lifting bar.

18. The method as claimed in claim 17, wherein, to carry out a reversal measurement, the lifting bar is lowered and the roller set is set into rotational movement.

19. The method as claimed in claim 17, wherein, for chassis adjustment, at least one wheel of the vehicle is positioned on the roller set and stands on the floating plate of the raised lifting bar.

20. The method as claimed in claim 17, wherein, for a rolling test, the wheel of the vehicle is positioned on the roller set and the lifting bar is lowered for the rolling test.

21. The method as claimed in claim, wherein the vehicle is positioned in a drive-out position with its wheel on the roller set, and in the drive-out position the lifting bar is raised.

22. A computer program product comprising commands that cause a vehicle test stand to carry out the steps of the method as claimed in claim 17, in particular
wherein, in a drive-in position of the vehicle, a lifting bar of the roller assembly is raised between two rollers of a roller set of the roller assembly in the direction of a vertical axis, and a wheel of the vehicle is arranged on the roller set with respect to the transverse axis;
wherein, on the vehicle test stand to selectively carry out a reversal measurement, the lifting bar is lowered with respect to the vertical axis and the roller set is set into rotational movement by a drive unit and the wheel is placed on the roller set and the roller set is rotated about the vertical axis as required;
wherein, on the vehicle test stand, for selective chassis adjustment, a wheel of the vehicle is positioned on the roller set and stands on the floating plate of the raised lifting bar;
wherein, on the vehicle test stand, for the selective rolling test, the lifting bar is lowered and the rollers are set into rotational movement by a drive unit and the roller set is rotated about the vertical axis as required;
wherein, in a drive-out position of the vehicle, the vehicle is positioned with its wheel on the roller set and with the lifting bar raised.

23. A computer program comprising commands that cause a vehicle test stand having at least one roller assembly to carry out the steps of the method as claimed in claim 17.

24. A computer-readable medium on which the computer program as claimed in claim 23 is stored.
